(19) United States
(12) Patent Application Publication
(10) Pub. No.: US 2007/0292341 A1
(43) Pub. Date: Dec. 20, 2007

(54) Method of producing hydrogen and hydrogen production apparatus

(75) Inventor: Masayoshi Kitada, Saitama (JP)

Correspondence Address: KRATZ, QUINTOS & HANSON, LLP, 1420 K Street, N.W., Suite 400, WASHINGTON, DC, 20005, US

(73) Assignee: HONDA MOTOR CO., LTD., Tokyo (JP)

(21) Appl. No.: 11/802,821

(22) Filed: May 25, 2007

(30) Foreign Application Priority Data
May 29, 2006 (JP) 2006-148913

(51) Int. Cl. C01B 6/24; B01J 19/00; B01J 8/08

(52) U.S. Cl. 423/644; 423/658.2; 422/198; 422/232

(57) ABSTRACT

A method of producing hydrogen which comprises steps of: forming a structure, which is formed from at least one of silicon and silicon oxide and has a plurality of holes having an energy concentrated field; and contacting the structure with water vapor at a temperature which is not less than 500° C. and not more than 1000° C.

### CROSS REFERENCE TO RELATED APPLICATIONS

This application claims the foreign priority benefit under Title 35, United States Code, §119(a)-(d) of Japanese Patent Application No. 2006-148913, filed on May 29, 2006, the contents of which are hereby incorporated by reference.

### BACKGROUND OF THE INVENTION

1. Field of the Invention

The present invention relates to a method of producing hydrogen and a hydrogen production apparatus using a structure which has a plurality of continuous holes which have an energy concentrated field.

2. Description of the Related Art

In recent years, hydrogen (H₂) has been a focus of attention as an alternative fuel to oil in consideration of depletion of existing resources, such as oil, and considering reducing carbon dioxide (CO₂) emission.

Conventionally, electrolysis of, for example, an electrolyte such as water (H₂O), acid, and alkali has been a general method for producing hydrogen as an alternative fuel. Theoretically, a potential difference of 1.23 V is required in a standard condition for producing hydrogen by electrolysis of water. However, since water has a high electric resistance, a relatively higher potential difference of 1.7 V is required even if an electrolyte, for example, alkali is dissolved in the water. Therefore, a relatively large amount of energy is required for electrolysis of water. Accordingly, a hydrogen production by the electrolysis of water becomes expensive, then, the electrolysis is not a practical method.

Thermal decomposition of water is another candidate for producing hydrogen. However, so high a temperature as above 4300° C. is required for producing a hydrogen gas through thermal decomposition of water. Therefore, a larger amount of energy than that of the electrolysis of water is required for maintaining the high temperature. Accordingly, the thermal decomposition of water results in a high cost and impracticality.

As a method of producing hydrogen gas at a low temperature of not more than 100° C., a hydrogen production method which generates hydrogen by oxidizing silicon (Si) powder with water has been proposed in, for example, Japanese Laid-open Patent Publication No. 2004-115349.

However, in the hydrogen production method proposed in the Japanese Laid-open Patent Publication No. 2004-115349, a generation rate of a hydrogen gas (hereinafter, referred to as hydrogen) is slow. Hydrogen production at a low temperature with a small energy is revolutionary, and a reason for the slow generation rate of hydrogen has been thought due to a small amount of input energy.

Because of an expensive cost for producing hydrogen as an alternative fuel, it is impossible to consume a large amount of energy. On the other hand, a thermal energy, which is generated in daily lives from, for example, an incinerator and a combustor, is released as waste heat. In recent years, the waste heat is re-evaluated and recovered as a usable thermal energy for, for example, supplying hot water. A temperature of waste heat from an incinerator and a combustor is in a range between 500° C. and 1000° C. Practically, a temperature of engine waste gas of an automobile is in a range between 500° C. and 1000° C. If hydrogen can be produced by utilizing the waste heat, an improvement of a generation rate of hydrogen may be achieved, and in addition, a cost for generating a thermal energy corresponding to an amount of the waste heat can be reduced. Accordingly, hydrogen may come to be used practically as an alternative fuel.

Based on the view point described above, an object of the present invention is to provide a method of producing hydrogen and a hydrogen production apparatus which have a high generation rate of hydrogen at a temperature between 500° C. and 1000° C., which is a temperature range of waste heat.

### SUMMARY OF THE INVENTION

According to the first aspect of the present invention, there is provided a method of producing hydrogen which comprises steps of: forming a structure which includes a plurality of holes which have an energy concentrated field from at least one of silicon and silicon oxide; and generating water vapor, wherein the structure comes in contact with the water vapor at a temperature of not less than 500° C. and not more than 1000° C.

In the present invention, since the water vapor can come in contact with the structure, the water vapor can be introduced to the energy concentrated field which is formed in the holes. Since the energy concentrated field is heated up at the temperature which is not less than 500° C. and not more than 1000° C., the water vapor can be easily excited by the concentrated energy, and as a result, hydrogen can be produced from water vapor with a high rate. If hydrogen is produced from water vapor with a high rate, a hydrogen production rate can be increased.

It is preferable to heat up at least one of the structure and the water vapor at the temperature of not less than 500° C. and not more than 1000° C., and to make the water vapor to come in contact with the structure by having the water vapor pass through the holes which are continuous holes. With the above process, the energy concentrated field can be easily heated up at the temperature of not less than 500° C. and not more than 1000° C., and the water vapor can be easily introduced to the energy concentrated field.

Since it is only necessary to heat up at least one of the structure and the water vapor at the temperature of not less than 500° C. and not more than 1000° C., utilization of waste gas becomes available for heating up at least one of the structure and the water vapor at the temperature of not less than 500° C. and not more than 1000° C. As a result, a cost of hydrogen production can be reduced.

According to a second aspect of the present invention, there is provided a hydrogen production apparatus which comprises: a reaction chamber which has a structure made of at least one of silicon and silicon oxide and includes a plurality of continuous holes which have an energy concentrated filed; water vapor generating means for generating water vapor to be supplied to the reaction chamber; water vapor supplying means for supplying the water vapor to the reaction chamber; and heating means for heating up the reaction chamber at a temperature of not less than 500° C. and not more than 1000° C., wherein hydrogen is produced by having the water vapor pass through the structure via the continuous holes.

In the present invention, since the water vapor can pass through the continuous holes of the structure, the water vapor can be introduced to the energy concentrated field. In the energy concentrated field, since the water vapor is heated by the structure which is heated up at the temperature of not less than 500° C. and not more than 1000° C., the water vapor can be easily excited by the concentrated energy, and as a result, hydrogen can be produced from the water vapor with a high rate. If hydrogen is produced from water vapor with a high rate, a hydrogen production rate can be increased.

It is preferable that the structure is formed by arranging the particles, which are made of at least one of silicon and silicon oxide, at positions where a wave energy specific to one of the silicon and silicon oxide is amplified to form the energy concentrated field among particles. In the structure where a plurality of particles are arranged, there exist spaces among the particles, and the spaces form cancellous-shaped continuous holes communicating with one another. In addition, the plurality of particles come close to the space among the particles, thereby increasing an energy potential in the space to form the energy concentrated field. As described above, a plurality of continuous holes which have the energy concentrated field can be easily formed using the particles.

According to the present invention, a method of producing hydrogen and a hydrogen production apparatus can be provided, both of which have a high hydrogen production rate at the waste gas temperature range of not less than 500° C. and not more than 1000° C.

### BRIEF DESCRIPTION OF THE DRAWINGS

FIG. 1 is an illustration showing a configuration of a hydrogen production apparatus according to one of embodiments of the present invention;

FIG. 2A is an illustration showing an arrangement of particles of a structure on a virtual plane in a hydrogen production apparatus;

FIG. 2B is an illustration showing an enlarged view of FIG. 2A;

FIG. 2C is an illustration showing an arrangement of the particles of the structure in three dimensions;

FIG. 2D is an illustration showing an enlarged view of FIG. 3C;

FIG. 3 is an illustration showing a configuration of a hydrogen production apparatus according to a first embodiment of the present invention;

FIG. 4A is a table showing a gas with a ratio by volume in a hydrogen production apparatus before reaction;

FIG. 4B is a table showing a gas with a ratio by volume in the hydrogen production apparatus after reaction where a temperature of a structure is at 430° C.;

FIG. 4C is a table showing a gas with a ratio by volume in the hydrogen production apparatus after reaction where a temperature of a structure is at 520° C.;

FIG. 4D is a table showing a gas with a ratio by volume in the hydrogen production apparatus after reaction where a temperature of a structure is at 597° C.;

FIG. 4E is a table showing a gas with a ratio by volume in the hydrogen production apparatus after reaction where a temperature of a structure is at 714° C.;

FIG. 4F is a table showing a gas with a ratio by volume in the hydrogen production apparatus after reaction where a temperature of a structure is at 730° C.;

FIG. 5 is a graph showing a hydrogen generation rate vs a structure temperature;

FIG. 6 is an illustration showing a configuration of a hydrogen production apparatus according to a second embodiment of the present invention;

FIG. 7 is an illustration showing a configuration of a reaction chamber of the hydrogen production apparatus according to the second embodiment;

FIG. 8A is a picture of a structure of the hydrogen production apparatus according to the second embodiment;

FIG. 8B is an enlarged picture of FIG. 8A;

FIG. 8C is an enlarged picture of FIG. 8B;

FIG. 9 is a table showing a gas with a ratio by volume and a volume after reaction where a temperature of a structure according to the second embodiment is at 1000° C.;

FIG. 10 is a circular chart showing a ratio between hydrogen volumes which are produced by thermal decomposition of water vapor and by oxidation reaction of silicon, according to the second embodiment;

FIG. 11 is a table showing a gas with a ratio by volume and a volume after reaction where a temperature of a structure according to a third embodiment is at 1000° C.;

FIG. 12 is a circular chart showing a ratio between hydrogen volumes which are produced by thermal decomposition of water vapor and by oxidation reaction of silicon, according to the third embodiment;

FIG. 13 is a table showing a gas with a ratio by volume after heating where a temperature of a structure of a first comparative example is heated up at 750° C. and water vapor is not supplied;

FIG. 14 is a table showing a gas with a ratio by volume after heating where a temperature of a structure of a third comparative example is heated up at 1010° C. and water vapor is not supplied;

FIG. 15 is an illustration showing a configuration of a hydrogen production apparatus according to a fourth embodiment of the present invention;

FIG. 16A is a table showing a gas with a ratio by volume and a volume after reaction where a temperature of a structure made of silicon oxide according to the fourth embodiment is at 1000° C.;

FIG. 16B is a table showing a gas with a ratio by volume and a volume after reaction where a temperature of a structure made of silicon oxide according to a fifth embodiment is at 1000° C.; and

FIG. 16C is a table showing a gas with a ratio by volume and a volume after reaction where a temperature of a structure made of silicon oxide according to a sixth embodiment is at 1000° C.

### DETAILED DESCRIPTION OF THE PREFERRED EMBODIMENT

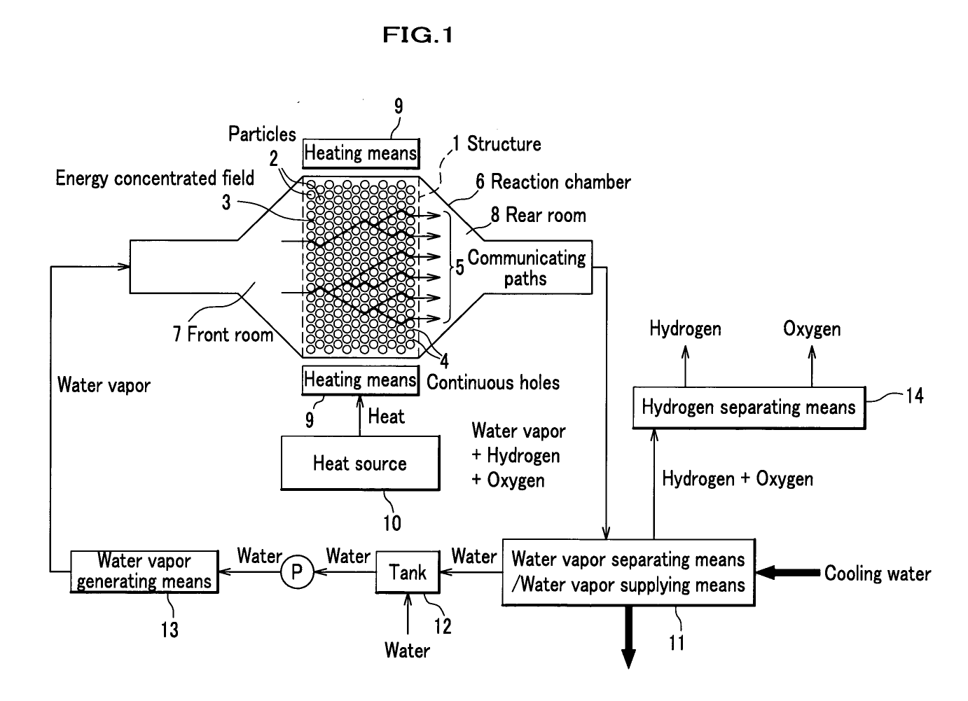

As shown in FIG. 1, a hydrogen production apparatus according to embodiments of the present invention includes a structure 1 which is made of at least one of silicon and silicon oxide and has a plurality of continuous holes 4 which have an energy concentrated field 3, a heating means 9 for heating up the structure 1 at a temperature not less than 500° C. and not more than 1000° C., a water vapor generating means 13 for generating water vapor, and a reaction chamber 6 which is configured so that water vapor passes through the continuous holes 4.

In the hydrogen production apparatus according to the embodiments of the present invention, since water vapor can pass through the continuous holes 4 of the structure 1, the water vapor can be introduced in the energy concentrated field 3, which is formed in the continuous holes 4. In the energy concentrated field 3, since the water vapor is heated by the structure 1 which is heated up at a temperature not less than 500° C. and not more than 1000° C., the water vapor is easily excited by the energy concentrated field 3. As a result, hydrogen can be produced from the water vapor at a high rate. If a rate of hydrogen generation from the water vapor is high, a generation rate of hydrogen can be increased.

The hydrogen production apparatus according to the embodiments of the present invention, further includes a water vapor separating means 11 for separating unreacted water vapor from hydrogen which is produced in the structure 1, a hydrogen separating means 14 for separating hydrogen from other gases such as oxygen and nitrogen, a tank 12 for storing water to be vaporized by the water vapor generating means 13, while water being fed from outside as well as storing a water which is condensed from water vapor separated by the water vapor separating means 11, and a pump P for supplying water to the water vapor generating means 13 from the tank 12.

For heating up the structure 1 by the heating means 9, waste heat which is generated in a heat source 10 is used, which is located outside the hydrogen production apparatus according to the embodiments. A production cost of hydrogen can be reduced by utilizing the waste heat. It is noted that a waste gas of an automobile engine, an incinerator, a combustor, and the like can be utilized as the heat source 10.

In the structure 1, the energy concentrated field 3 is formed among particles 2. The particles 2 are made of at least one of silicon and silicon oxide and arranged at positions where a wave energy which is inherent to silicon or silicon oxide is amplified. In the structure 1 where a plurality of the particles 2 are arranged, there exist spaces among the particles 2, and the spaces form cancellous-shaped continuous holes 4 communicating with one another. The water vapor can pass the structure 1 through communicating paths 5 which connect a front and back of the structure 1 via the continuous holes 4. In addition, the plurality of the particles 2 come close to the space among the particles 2, thereby increasing an energy potential in the space to form the energy concentrated field 3. As described above, a plurality of continuous holes 4 which have the energy concentrated field 3 can be easily formed using the particles 2.

The reaction chamber 6 includes a front room 7 and a rear room 8 which are separated by the structure 1. Since the front room 7 and the rear room 8 are separated by the structure 1, the water vapor inevitably passes through the continuous holes 4 for moving to the rear room 8 from the front room 7. When the water vapor which contains, for example, hydrogen reaches a water vapor separating means 11, the water vapor is condensed into water due to cooling by cooling water and the like, and a volume of the water vapor is drastically shrunk. Due to the above shrinkage, a strong negative pressure (suctioning force) is generated, which causes feeding the water vapor, which is generated in the water vapor generating means 13, to the reaction chamber 6 and forcibly having the water vapor pass through the continuous holes 4 of the structure 1. That is, if a generation of water vapor in the water vapor generating means 13 and a condensation of the water vapor in the water vapor separating means 11 are continued, the water vapor is continuously supplied to the structure 1 and the water vapor continuously passes through the continuous holes 4. As described above, the water vapor separating means 11 also has another function as a water vapor supplying means for supplying water vapor to the structure 1.

In addition, the hydrogen separating means 14 separates and recovers hydrogen, which is a desired gas, from generated gases. For example, hydrogen is obtained by separating the hydrogen from the generated gases using a difference in specific gravity of each of the gases. Hydrogen is also obtained by retrieving the hydrogen using adsorbents, absorbents (for example, silica, alumina, active carbon, etc.) and the like which absorbs only a specific gas. In addition, hydrogen is obtained and by separating the hydrogen from the generated gases using, for example, a membrane through which only a specific gas can pass.

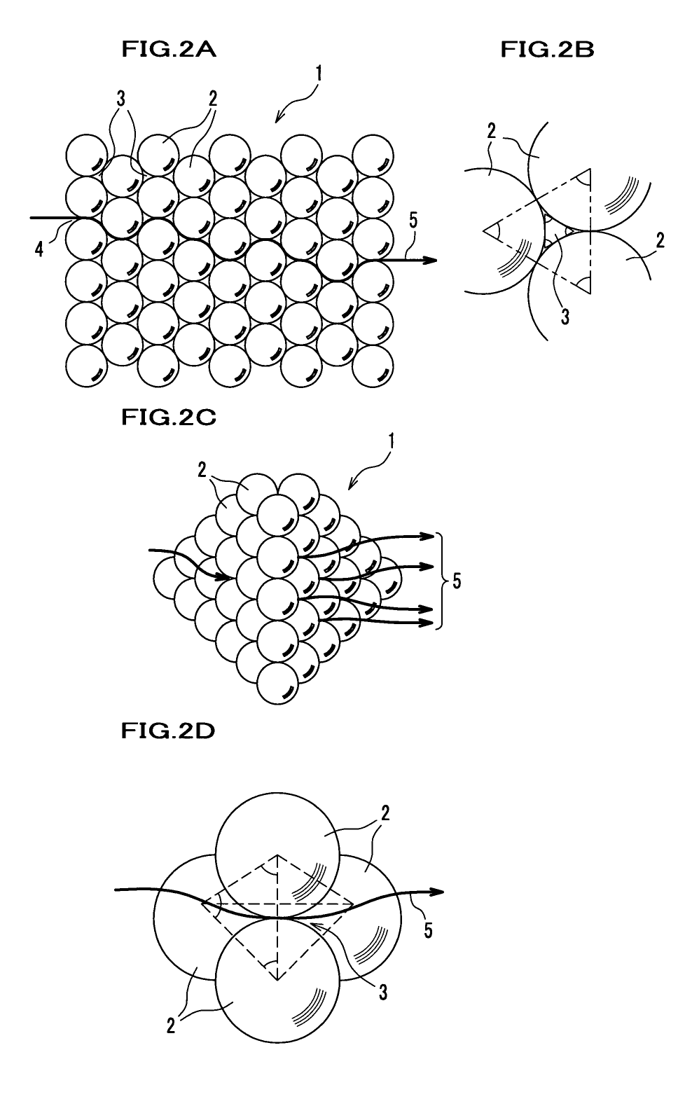

As shown in FIG. 2A and FIG. 2B, the structure 1 is configured such that a gravity center of the particles 2 is positioned at each apex of a triangle, preferably at each apex of a regular triangle. Positioning of the particles 2 at the apexes of a triangle, especially at the apexes of a regular triangle is to form an arrangement in which a wave energy inherent to silicon or silicon oxide is amplified by increasing amplitude of the wave due to superposition of waves. In addition, the arrangement can be easily achieved by close-packing the particles 2. It is noted that an ideal arrangement is to form a regular triangle with a center of the particles 2 by contacting the particles 2 with one other, which substantially have an identical diameter. However, the arrangement is not limited to the above if the wave energy can be amplified, even if a small number of the particles 2 is not in contact with each other.

Also, as shown in FIG. 2C and FIG. 2D, the structure 1 is configured such that a gravity center of the particles 2 is positioned at each apex of a tetrahedral, preferably at each apex of a regular tetrahedral. Positioning at the apexes of a tetrahedral of the particles 2, especially at the apexes of a regular tetrahedral is an arrangement in which the wave energy inherent to silicon or silicon oxide is amplified. In addition, the arrangement can be easily achieved by close-packing the particles 2. It is noted that an ideal arrangement is to form a regular triangle with a center of the particles 2 by contacting the particles 2 with one another, which practically have an identical diameter. However, the arrangement is not limited to the above if the specific wave energy can be amplified, even if a part of the particles 2 does not come in contact with each other.

Since the structure 1 is made of silicon and silicon oxide, the structure 1 contains silicon atoms. Since an ionization energy E specific to a silicon atom is 8.144 eV, an electromagnetic wave of the silicon atom oscillates at a specific frequency of ν=1.971×10¹⁵ Hz when the silicon atom is ionized, where ν satisfies the formula E=hν (where, h is a Planck's constant, ν is a frequency). The electromagnetic frequency has a specific fluctuation, and it proves that the electromagnetic wave may oscillate at the specific frequency ν even in a usual condition other than the ionization condition. By arranging the particles 2 at positions where an oscillation energy of the frequency ν, which is specific to the silicon atom of each of the particles 2, can be effectively amplified by resonation, the energy concentrated field 3 which can give a large amount of wave energy to water vapor is formed among the particles 2, specifically, among the silicon atoms in different particles 2. Accordingly, it proves that hydrogen is produced from the water vapor since the wave energy is given to water vapor when the water vapor passes through the energy concentrated field 3.

In addition, if the particles 2 have a spherical shape, an arrangement of the particles 2 at positions where the wave energy is amplified becomes easy. A single layer of the particles 2 may be formed. The single layer may be stacked. It is preferable that a ratio of a minor axis to a major axis of the particles 2 is not less than 0.3, and more preferably the ratio is between 0.8 and 1. If the ratio is not less than 0.3, the energy concentrated field 3 can be formed without faults. On the contrary, if the particles 2 which have the ratio less than 0.3 are arranged, it becomes difficult to effectively form the energy concentrated field 3 among the particles 2.

It is preferable that a diameter range of the particles 2 is not less than 5 μm and not more than 80 μm. The reasons are as follows. Manufacturing particles which have a diameter less than 5 μm is relatively difficult. In addition, a passing of water vapor through a space among the particles 2, which is the energy concentrated field 3, is also relatively difficult when the particles 2 are arranged at regular positions. Further, when a diameter of the particles 2 is not less than 80 μm, a volume density of the energy concentrated field 3 can not be increased since a sufficient energy is not produced among the particles 2 when the particles 2 are arranged.

In addition, it is preferable that a particle size distribution of the particles 2 is narrower for the hydrogen production. It is preferable that a particle size of the particles 2 is within a range between 75% and 125% of an average particle size of the particles 2. Specifically, when the average particle size is 40 μm, it is preferable that the particle size is within a range between 40+10 μm and 40−10 μm, and when the average particle size is 60 μm, it is preferable that the particle size is in a range between 60+15 μm and 60−15 μm. Since the energy concentrated field 3 can be arranged with a constant interval, the wave energy can be easily amplified.

It is preferable that the structure 1 is formed by stacking 5 to 15 layers of the particles 2 to form the structure 1. In addition, it is preferable that a thickness of the structure 1 is not less than 0.35 mm and not more than 1.5 mm, and more preferably not less than 0.5 mm and not more than 1.0 mm. When the structure 1 is formed of less than 5 layers or less than 0.35 mm in thickness of the structure 1, a careful handling of the structure 1 is required for preventing a fracture and the like of the structure 1. On the other hand, when the structure 1 is formed of more than 15 layers or more than 1.5 mm in thickness of the structure 1, water vapor hardly passes through the structure 1 due to, for example, a pressure loss.

It is preferable that a void ratio of the structure 1 ranges between 45% and 60%. When the void ratio is within the range, the water vapor can easily pass through the structure 1. Therefore, the structure 1 can be prevented from being damaged, for example, by a pressure difference between both sides of the structure 1. If the void ratio is less than 45%, a high pressure is required for having the water vapor pass. Then, a fracture of the structure 1 and a clogging up of a space of the energy concentrated field 3 with impurities in the water vapor may be caused. On the contrary, if the void ratio is more than 60%, a volume density of the energy concentrated field 3 in the continuous holes 4 becomes low. Then, an activation of the water vapor may become difficult for producing hydrogen because the water vapor can not stay for a sufficient time to be excited in the energy concentrated filed 3.

It is preferable that a purity of silicon which forms the structure 1 is not less than 90%, and more preferably not less than 95%. Also, a preferable purity of silicon oxide is not less than 90%, and more preferably not less than 95%. In addition, when the structure 1 is formed from silicon and silicon oxide, a preferable impurity concentration except the silicon and silicon oxide is not more than 10%, and more preferably not more than 5%. As described above, the purer the silicon and silicon oxide are, the better for the hydrogen production. The structure 1 may be formed with only silicon, or only silicon oxide, or silicon and silicon oxide. In addition, the following procedure may be adopted for producing hydrogen. Initially, the structure 1 is formed from only silicon. Next, the silicon is gradually changed into a mixture of silicon and silicon oxide due to oxidation of the silicon during production of hydrogen. Finally, the hydrogen is produced by only silicon oxide which is formed by complete oxidation of the silicon.

Next, a manufacturing method of the structure 1 will be explained.

First, the particles 2 are manufactured. The particles 2 can be manufactured with a gas atomization method. The gas atomization method is a most commonly used method for manufacturing a catalytic particle. Since the method is simple and a shape of the manufactured particle is relatively uniform, the method can be applied to a manufacturing of the particles 2. In addition, other than the gas atomization method, for example, a jet milling method and a sol-gel method can be applied to a manufacturing of the particles 2. The jet milling method is also a general method for manufacturing a catalytic particle as the gas atomization method, and the method can be applied manufacturing the particles 2.

Next, for making an arrangement of each of the particles 2 easy, an antistatic treatment is performed on the particles 2. Since the particles 2 are charged, the particles 2 adhere to or repulse each other by static electricity when the particles 2 are arranged. Therefore, the arrangement of each of the particles 2 at an intended position is difficult in some case. Because of the above reason, positive and negative ions are irradiated on the particles 2 to cancel the electrostatic charge.

The particles 2 are arranged as shown in FIG. 2C in a frame, and sintered to form a predetermined shape, for example, a plate. For sintering conditions, a sintering temperature is not more than a melting point of silicon or silicon oxide, but sintering is available at the temperature. For example, in a case of silicon, the temperature is within a range not less than 1200° C. and not more than 1300° C. A sintering time is not less than 2.5 hours and not more than 3.5 hours. In addition, a sintering pressure is within a range not less than 12 MPa and not more than 25 Mpa. It is noted that in sintering to form the structure 1, it is preferable not to use a binder, different from a case of usual sintering. If a binder is used for the sinter forming, an arrangement of the energy concentrated field 3 among the particles 2 becomes difficult. In addition, impurities from the binder may adhere to a surface of each of the particles 2 and an activity of the particles 2 may be lost.

### First Embodiment

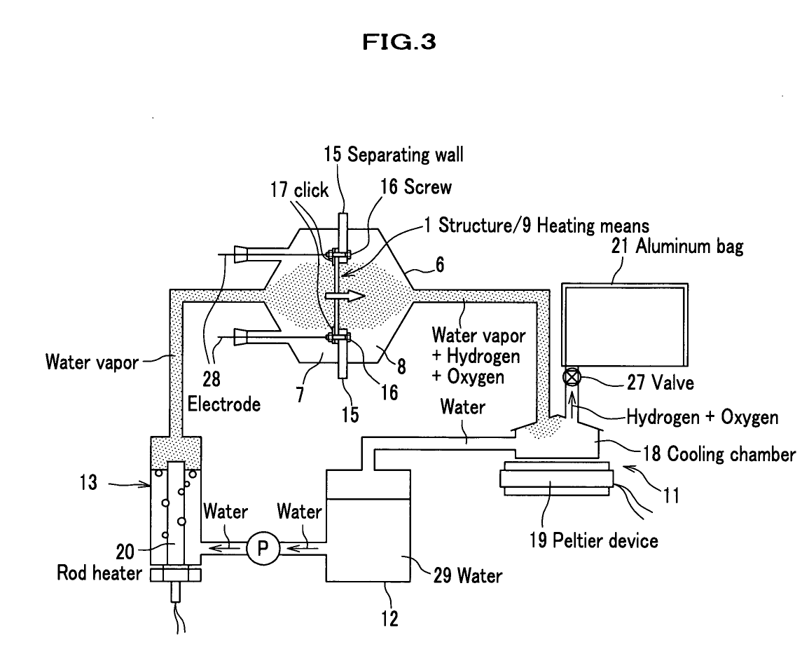

As shown in FIG. 3, a hydrogen production apparatus according to a first embodiment of the present invention also includes the structure 1, the reaction chamber 6, the water vapor separating means 11, the tank 12, the pump P, and the water vapor generating means 13, as in the case of the hydrogen production apparatus according to the embodiments shown in FIG. 1.

The structure 1 is fixed to a separating wall 15 by a click 17. The click 17 is fixed to the separating wall 15 by a screw 16. In addition, an electrode 28 is electrically connected to the structure 1 by the screw 16. The electrode 28 is connected to a power source (not shown), and an electric current can be applied to the structure 1 by the power source through the electrode 28. The structure 1 is made of silicon and generates heat as a resistor when it is applied the electric current to increase a temperature of the structure 1. The temperature of the structure 1 can be changed by varying the electric current. The temperature of the structure 1 is set at 430° C., 520° C., 597° C., 714° C., and 730° C., which will be described later. As described above, the structure 1 can be thought to have both functions of the heating means 9 and the heat source 10 in FIG. 1. Since this is a small-scale experiment for proving a high production rate of hydrogen, waste heat is not used for heating the structure 1

Water 29 is pooled in the tank 12, and the water 29 is supplied to the water vapor generating means 13 by the pump P. The water vapor generating means 13 has a rod heater 20, and the rod heater 20 evaporates the water 29 by heating the water 29 to generate water vapor. The water vapor is supplied to the front room 7 of the reaction chamber 6. Since the front room 7 and the rear room 8 of the reaction chamber 6 are separated by the structure 1 and the separating wall 15, the water vapor inevitably passes through the continuous holes 4, which are formed in the structure 1, for moving to the rear room 8 from the front room 7. Hydrogen is produced by having the water vapor pass through the continuous holes 4. Unreacted water vapor and generated hydrogen are supplied to the water vapor separating means 11 through the rear room 8.

The water vapor separating means 11 includes a Peltier device 19 and a cooling chamber 18. The cooling chamber is cooled by the Peltier device, and thereby, water vapor and hydrogen are cooled. Therefore, only the water vapor is condensed into water and the water flows into a tank 12. On the other hand, the hydrogen remains in a gas state. As a result, the hydrogen can be separated from the water vapor. The hydrogen is stored in an aluminum bag 21 by opening a valve 27. It is noted that a reason for disposing the aluminum bag 21 with the valve 27 instead of the hydrogen separating means 14 in FIG. 1 is to measure a volume of the generated hydrogen accurately.

Next, a hydrogen production process using a hydrogen production apparatus according to the first embodiment will be explained.

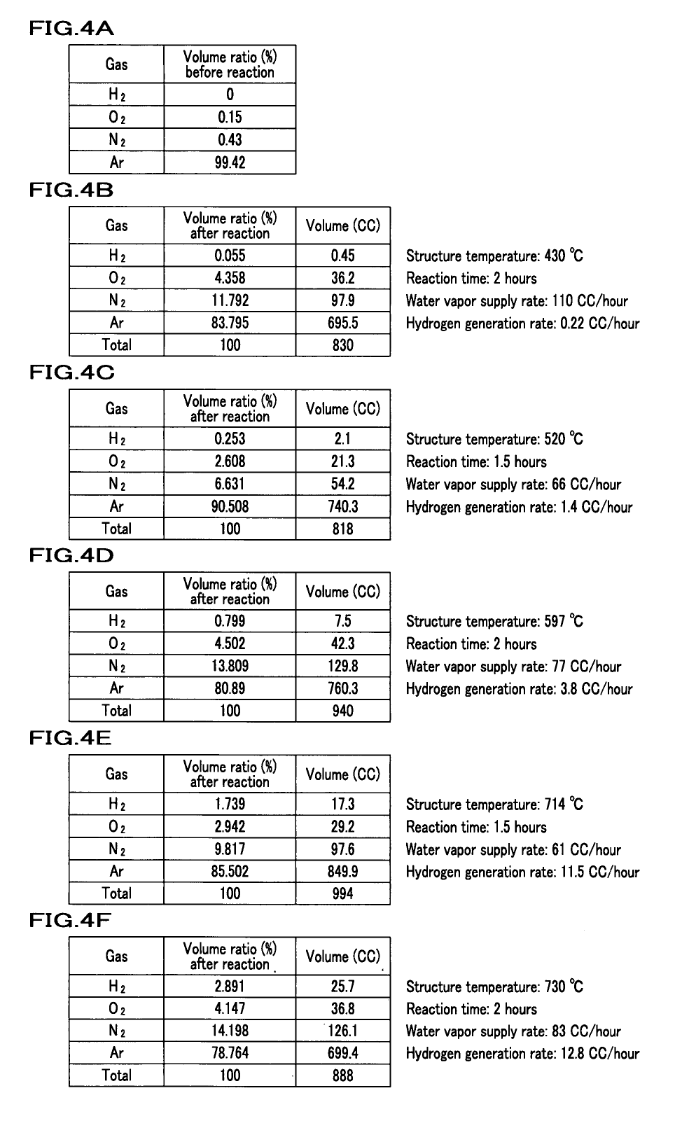

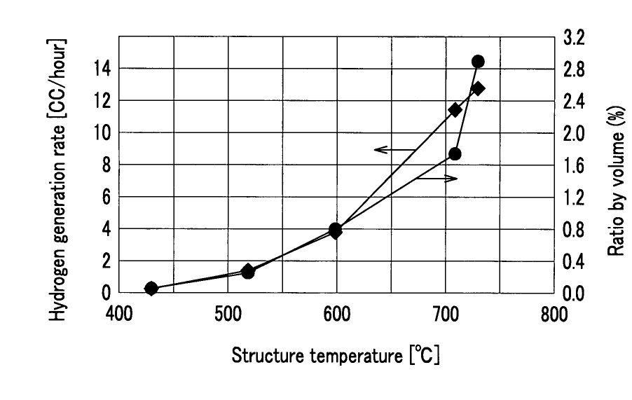

As shown in FIG. 4A, a gas in the hydrogen production apparatus was replaced by a gas which contains Ar as a dominant composition. When the gas was replaced, a temperature of the structure 1 was raised up to 430° C. to sufficiently degas the structure 1 and the reaction chamber 6. It is noted that a composition of the gas was measured using a gas-chromatography.

Next, as shown in FIG. 4B, an electric current was applied to the structure 1, and a temperature of the structure 1 was set at 430° C. Then, water vapor was generated for two hours by the water vapor generating means 13 and a volume of the water vapor which passed through the structure 1 was 110 CC/hour. At this time, the water vapor was condensed into water 29 by the water vapor separating means 11 to return to the tank 12, and a remaining gas was collected in the aluminum bas 21. It is noted that a gas which is flown into the aluminum bag 21 due to expansion of the gas by the heated structure 1 and the rod heater 20 is included in the collected gas. As shown in FIG. 4B, hydrogen was included in the collected gas, where a hydrogen concentration was 0.055% by volume and a hydrogen volume was 0.45 CC. A generation rate of hydrogen was 0.22 CC/hour. In addition, by comparing FIG. 4A and FIG. 4B, it was found that an oxygen concentration by volume and a nitrogen concentration by volume were also increased after the reaction compared with before the reaction.

Next, as shown in FIG. 4C, a temperature of the structure 1 was set at 520° C. after degassing. Then, water vapor was generated for 1.5 hours and a volume of the water vapor which passed through the structure 1 was 66 CC/hour. A remaining gas which passed through the structure 1 and from which the water vapor was removed was collected in the aluminum bag 21. As shown in FIG. 4C, hydrogen was included in the collected gas, where a hydrogen concentration was 0.253% by volume and a hydrogen volume was 2.1 CC. A generation rate of hydrogen was 1.4 CC/hour. In addition, by comparing FIG. 4A and FIG. 4C, it was found that an oxygen concentration by volume and a nitrogen concentration by volume were also increased after the reaction compared with before the reaction.

Next, as shown in FIG. 4D, a temperature of the structure 1 was set at 597° C. after degassing. Then, water vapor was generated for 2 hours and a volume of the water vapor which passed through the structure 1 was 77 CC/hour. A remaining gas which passed through the structure 1 and from which the water vapor was removed was collected in the aluminum bag 21. As shown in FIG. 4D, hydrogen was included in the collected gas, where a hydrogen concentration was 0.799% by volume and a hydrogen volume was 7.5 CC. A generation rate of hydrogen was 3.8 CC/hour. In addition, by comparing FIG. 4A and FIG. 4D, it was found that an oxygen concentration by volume and a nitrogen concentration by volume were also increased after the reaction compared with before the reaction.

Next, as shown in FIG. 4E, the temperature of the structure 1 was set at 714° C. after degassing. Then, water vapor was generated for 1.5 hours and a volume of the water vapor which passed through the structure 1 was 61 CC/hour. A remaining gas which passed through the structure 1 and from which water vapor was removed was collected in the aluminum bag 21. As shown in FIG. 4E, hydrogen was included in the collected gas, where a hydrogen concentration was 1.739% by volume and a hydrogen volume was 17.3 CC. A generation rate of hydrogen was 11.5 CC/hour. In addition, by comparing FIG. 4A and FIG. 4E, it was found that an oxygen concentration by volume and a nitrogen concentration by volume were also increased after the reaction compared with before the reaction.

Next, as shown in FIG. 4F, a temperature of the structure 1 was set at 730° C. after degassing. Then, water vapor was generated for 2 hours and a volume of the water vapor which passed through the structure 1 was 83 CC/hour. A remaining gas which passed through the structure 1 and from which the water vapor was removed was collected in the aluminum bag 21. As shown in FIG. 4F, hydrogen was included in the collected gas, where a hydrogen concentration was 2.891% by volume and a hydrogen volume was 25.7 CC. A generation rate of hydrogen was 12.8 CC/hour. In addition, by comparing FIG. 4A and FIG. 4F, it was found that an oxygen concentration by volume and a nitrogen concentration by volume were also increased after the reaction compared with before the reaction.

As shown in FIG. 5, a hydrogen concentration by volume in a collected gas depends on a temperature of the structure 1. When a temperature of the structure 1 was raised from 430° C. to 730° C., the hydrogen concentration by volume was increased from 0.055% to 2.891%. In addition, a hydrogen generation rate depends on the temperature of the structure 1, and when the temperature of the structure 1 was raised from 430° C. to 730° C., the hydrogen generation rate was increased from 0.22 CC/hour to 12.8 CC/hour. In the hydrogen production apparatus according to the first embodiment, a temperature of the structure 1 has not been raised to 1000° C. However, the results described above indicate that the hydrogen generation rate may be further increased if the temperature is further raised from 730° C. As a result, it was found that the hydrogen generation rate can be increased by setting the temperature of the structure 1 within a range not less than 500° C. and not more than 1000° C., which is a temperature range of waste heat. It is noted that although the oxygen concentration by volume and the nitrogen concentration by volume were increased after the reaction compared with before the reaction, it was not found that the increases depend on the temperature of the structure 1. It proves that a generation mechanism of the hydrogen is different from those of the oxygen and nitrogen.

### Second Embodiment

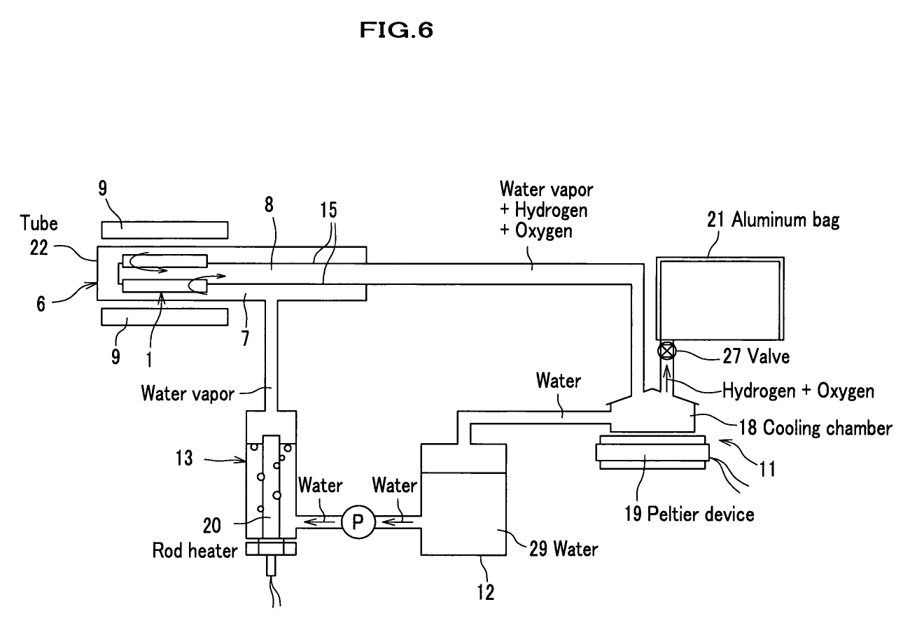

As shown in FIG. 6, a hydrogen production apparatus according to a second embodiment of the present invention includes the structure 1, the reaction chamber 6, the heating means 9, the water vapor separating means 11, the tank 12, the pump P, and the water vapor generating means 13, as with the hydrogen production apparatus according to the embodiment in FIG. 1. In addition, the hydrogen production apparatus according to the second embodiment includes the aluminum bag 21 with a valve 27, as with the hydrogen production apparatus according to the first embodiment in FIG. 3.

In the reaction chamber 6, a quartz tube 22 configures a chamber in which two plate structures 1 are arranged facing each other. A nichrome wire, which is the heating means 9, is wound on outer side of the quartz tube 22 so as to cover the structure 1. An electric current is applied to the nichrome wire to generate heat, and a temperature of the structures 1 is controlled by varying the electric current. Since this is a small experiment for confirming a hydrogen production with a high rate, waste heat was not used for heating the structures 1.

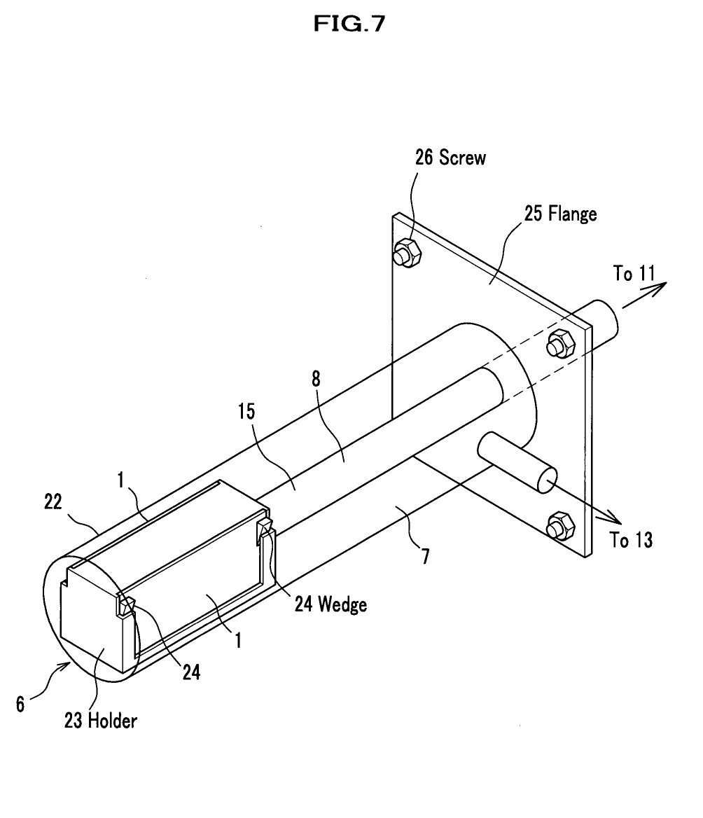

As shown in FIG. 6 and FIG. 7, the tube 22 is closed at one end, and the other end is also closed with a flange 25. The tube 22 and flange 25 are fixed in the hydrogen production apparatus by screws 26 which are disposed on the flange 25. The separating wall 15 is also made of quartz tube. The separating wall 15 is extended in the tube 22 through the flange 25 and connected with a holder 23. The two structures 1 are fitted in the holder 23 facing to each other, and fixed to the holder 23 by wedges 24. Water vapor which is outside the holder 23 can enter inside the holder 23 only by passing through the structure 1.

When water vapor is sent to the reaction chamber 6 from the water vapor generating means 13, the water vapor enters in the front room 7 which is located between the tube 22 and the separating wall 15. Since the rear room 8 of the reaction chamber 6 is located inside the tube separating wall 15, the front room 7 and the rear room 8 are separated from each other by the structure 1, holder 23, and separating wall 15. Therefore, the water vapor inevitably passes through the heated structure 1 to move to the rear room 8 from the front room 7. Hydrogen is produced by having the water vapor pass through the structure 1. Unreacted water vapor and produced hydrogen are sent to the water vapor separating means 11 through the rear room 8. In the water vapor separating means 11, the hydrogen and the water vapor are separated with a similar manner to the first embodiment, and the hydrogen is stored in the aluminum bag 21.

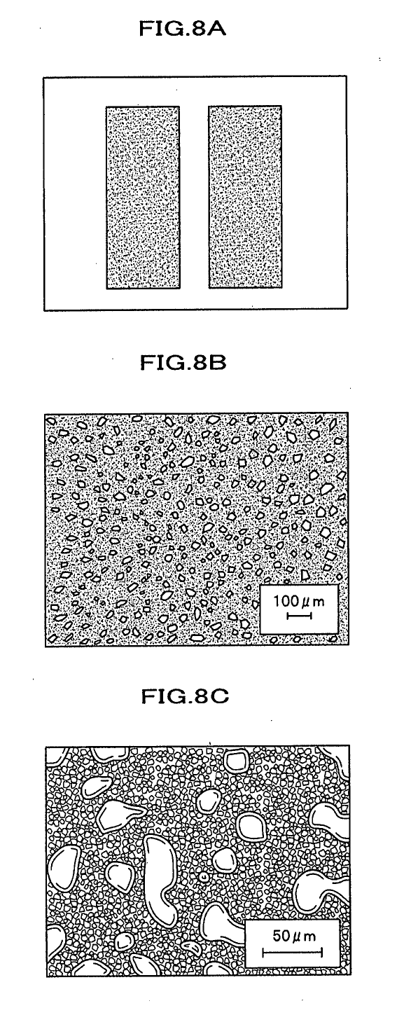

As shown in FIG. 8A, a dimension of the two plate structures 1 was 20 mm in width and 50 mm in length. A thickness of the structure 1 was 0.5 mm. The structures 1 were formed by sintering silicon particles 2 (see FIG. 1 and FIG. 2). As shown in FIG. 8B and FIG. 8C, the silicon particles 2 were manufactured by a gas atomization method. The particles 2 which are classified in a range not less than 53 μm and not more than 75 μm in diameter are used to form the structure 1.

Next, a hydrogen production process using the hydrogen production apparatus according to the second embodiment will be explained.

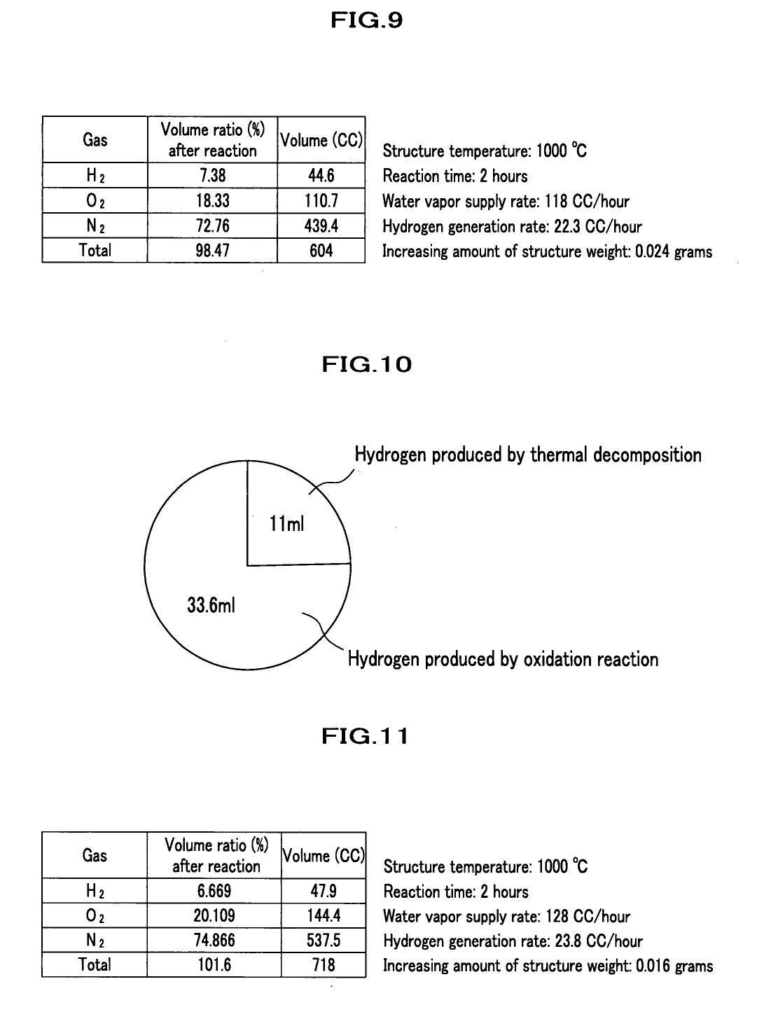

As shown in FIG. 9, an electric current is applied to the heating means 9, and a temperature of the structure 1 is set at 1000° C. Then, water vapor was generated by the water vapor generating means 13 for 2 hours and a volume of the water vapor which passed through the structure 1 was 118 CC/hour. At this time, the water vapor is condensed into water by the water vapor separating means 11 to return to the tank 12, and a remaining gas was collected in the aluminum bas 21. It is noted that a gas which comes into the aluminum bag 21 due to expansion of the gas by a heated structure 1 and a rod heater 20 is included in the collected gas. As shown in FIG. 9, hydrogen was included in the collected gas in which a hydrogen concentration was 7.38% by volume and a hydrogen volume was 44.6 CC. A generation rate of hydrogen was 22.3 CC/hour. In addition, it was found that a weight of the structure 1 was increased from 1.996 grams to 2.020 grams after the reaction. An amount of the increase was 0.024 grams. It proves that the increase is caused by oxidation of silicon, which is a material making up the structure 1, thereby incorporating oxygen into the structure 1.

Then, an amount of hydrogen gas which is produced by hydrogen atoms originated from water vapor was calculated based on the following assumptions. As shown in a flowing reaction formula, silicon oxide is formed by oxidation of silicon with water vapor. On the other hand, the water vapor is reduced by losing oxygen, thereby resulting in production of hydrogen. The increase of 0.024 grams of the structure 1 comes from a weight of oxygen originated from the water vapor.
Si+2H₂O (water vapor)→2H₂+SiO₂

The amount of hydrogen to be produced by oxidation reaction of silicon, that is, as shown in FIG. 10, the calculation result was 33.6 CC. An amount of hydrogen which was actually collected was 44.6 CC. Therefore, it proves that a difference of 11 CC in amount of hydrogen between 44.6 CC and 33.6 CC may be attributed to thermal decomposition of the water vapor. It is also thought that thermal decomposition of the water vapor, which normally requires 4300° C., might be caused at 1000° C. due to a significant decrease of the thermal decomposition temperature by using the structure 1, thereby resulting in production of the 11 CC. Accordingly, it was found that by setting a temperature of the structure 1 at 1000° C., which is within a range of waste heat, the oxidation reaction of silicon and the thermal decomposition of water vapor were caused, thereby resulting in increase in hydrogen production rate.

### Third Embodiment

In a third embodiment, it was proved again whether or not oxidation reaction of silicon and thermal decomposition of water vapor were caused in the structure 1, using a hydrogen production apparatus which is identical to the second embodiment.

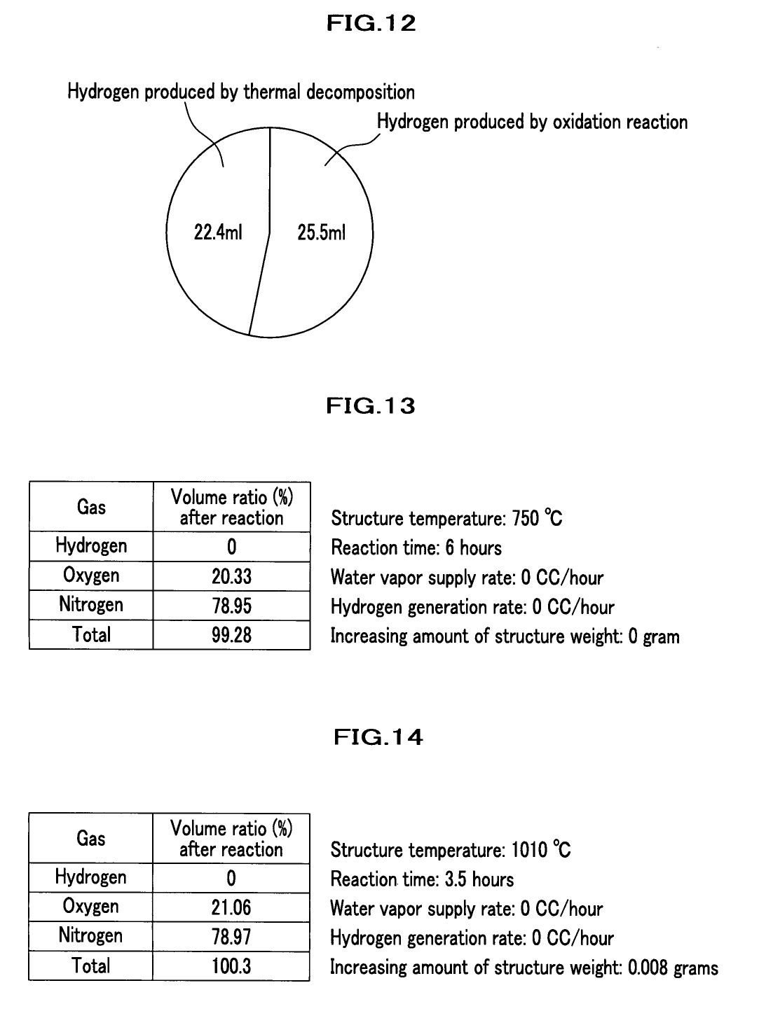

First, as shown in FIG. 11, a temperature of the structure 1 was set at 1000° C. Then, water vapor was generated for 2 hours and a volume of the water vapor which passed through the structure 1 was 128 CC/hour. A remaining gas which had passed through the structure 1 and from which the water vapor was removed was collected in the aluminum bas 21. As shown in FIG. 11, hydrogen was included in the collected gas in which a hydrogen concentration was 6.669% by volume and a hydrogen volume was 47.9 CC. A generation rate of hydrogen was 23.8 CC/hour. In addition, a weight of the structure 1 was increased from 2.022 grams to 2.038 grams after the reaction. An amount of the increase was 0.016 grams. As with the second embodiment, an amount of hydrogen which is produced by silicon oxidation was calculated. The amount was 22.4 CC as shown in FIG. 12. Since an amount of hydrogen which was actually collected was 47.9 CC. Therefore, it proves that a difference of 25.5 CC in amount of hydrogen between 47.9 CC and 22.4 CC might be produced by thermal decomposition of the water vapor. A ratio of the amount of hydrogen which was produced by the thermal decomposition to the whole amount of the produced hydrogen was 25% in the second embodiment. However, the ratio was 53% in the third embodiment. As described above, it was found that by setting a temperature of the structure 1 at 1000° C., which is within a range of waste heat, the thermal decomposition of the water vapor was accelerated to a degree where a hydrogen production rate is approximately as large as that of silicon oxidation, thereby resulting in increase in a total hydrogen production rate.

### First Comparative Example

The hydrogen production apparatus which is identical to the second embodiment was used in a first comparative example. As shown in FIG. 13, a temperature of the structure 1 was set at 750° C. for 6 hours. However, water vapor was not generated by the water vapor generating means 13, and as a result, water vapor was not passed through the structure 1. It is noted that the structure 1 was arranged in the tube 22 in FIG. 6 and not exposed to atmosphere. After a lapse of 6 hours, the temperature of the structure 1 was lowered, and a gas within the cooling chamber 18 was collected. As shown in FIG. 13, hydrogen was not found in the collected gas. In addition, a weight of the structure 1 was measured at before and after raising the temperature to 750° C. The weights at before and after raising the temperature were 1.988 grams and 1.987 grams, respectively. Therefore, an increase in the weight was not found. As described above, since hydrogen was not produced when water vapor was not passed through the structure 1, and since hydrogen was produced when the water vapor was passed through the structure 1 as described in the first to third embodiments, it proves that the water vapor is a source of the hydrogen. In addition, when hydrogen was not produced, a weight of the structure 1 was not increased. Therefore, it is found that silicon in the structure 1 was not oxidized due to lack of the water vapor.

### Second Comparative Example

The hydrogen production apparatus which is identical to the second embodiment was also used in a second comparative example. A temperature of the structure 1 was set at 750° C. for 2 hours. However, water vapor was not generated by the water vapor generating means 13, and as a result, water vapor was not passed through the structure 1. In addition, the tube 22 in FIG. 6 was opened to atmosphere so that air could be supplied to the structure 1. A weight of the structure 1 was measured at before and after raising the temperature to 750° C. The weights at before and after raising the temperature were 1.988 grams and 1.989 grams, respectively. Therefore, an increase in the weight was within a range of error. It is noted whether or not hydrogen had been produced was not measured because the tube 22 was exposed to the atmosphere. As described above, since an increase in the weight of the structure 1 was not found even when the tube 22 was exposed to the atmosphere for sufficiently supplying oxygen from atmosphere to the structure 1, it is known that silicon oxidation in the structure 1 was not caused. On the other hand, in the second and a third embodiments, since weights of the structure 1 were increased by supplying water vapor to the structure 1, indicating silicon oxidation of the structure 1, it turns out that silicon oxidation was caused by the water vapor.

### Third Comparative Example

The hydrogen production apparatus which is identical to the second embodiment was also used in a third comparative example. As shown in FIG. 14, a temperature of the structure 1 was set at 1010° C. for 3.5 hours. However, water vapor was not generated by the water vapor generating means 13, and as a result, water vapor was not passed through the structure 1. It is noted that the structure 1 was arranged within the tube 22, and not exposed to atmosphere. After a time of 3.5 hours elapsed, the temperature of the structure 1 was lowered, and a gas within the cooling chamber 18 was collected. As shown in FIG. 14, hydrogen was not found in the collected gas. In addition, a weight of the structure 1 was measured at before and after raising a temperature to 1010° C. The weights at before and after raising the temperature were 1.966 grams and 1.974 grams, respectively. Therefore, an increase in the weight was 0.008 grams. As described above, since hydrogen was not produced when water vapor was not passed through the structure 1, and since hydrogen was produced when water vapor was passed through the structure 1 as described in the first to third embodiments, it turns out that the water vapor is a source of the hydrogen. In addition, when oxygen and nitrogen were supplied from the atmosphere to the structure 1 instead of water vapor, a weight of the structure 1 was increased. Therefore, it is known that oxidation and nitridation of the structure 1 were caused by the oxygen and nitrogen from atmosphere when a temperature of the structure 1 was 1010° C. Assuming that the oxidation by oxygen and the nitridation by nitrogen were caused in the structure 1, oxidation by oxygen and nitridation by nitrogen were also caused in the structure 1 in the second and third embodiments since the temperature of the structure 1 was 1000° C. Since increases in the weights of the structure 1 in the second and third embodiments were caused by oxidation by oxygen and nitridation by nitrogen as well as oxidation by water vapor, it proves that more hydrogen than that of expected from the hydrogen rates which were calculated in the second and third embodiments was produced by thermal decomposition of water vapor.

### Fourth Embodiment

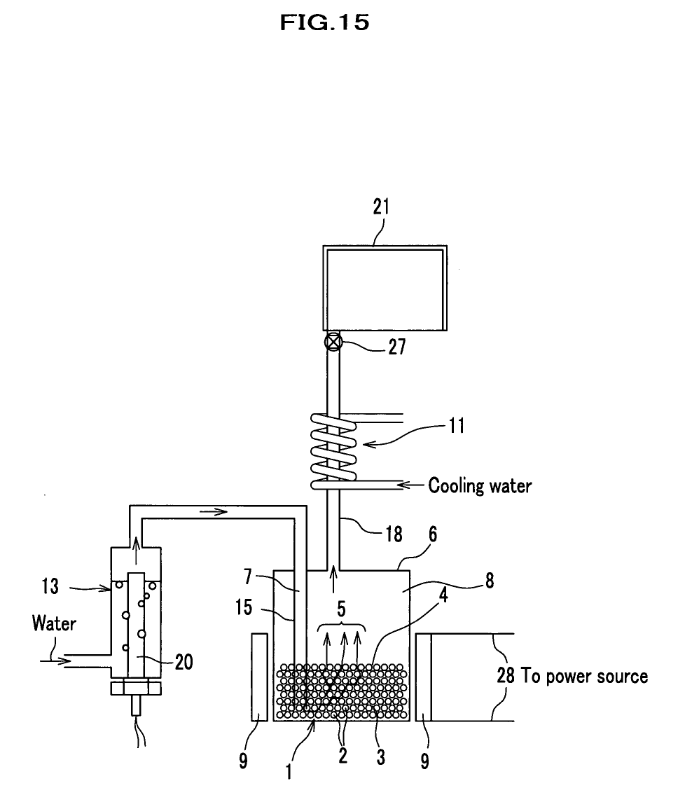

As shown in FIG. 15, a hydrogen production apparatus according to a fourth embodiment of the present invention includes the structure 1, the reaction chamber 6, the heating means 9, the water vapor separating means 11, and the water vapor generating means 13, as the hydrogen production apparatus according to the embodiment in FIG. 1. The structure 1 is different from that in FIG. 1. A plurality of particles 2 are formed with a powder or beads which are not bound with one another. The plurality of particles 2 are placed within the reaction chamber 6 to form a multi-layer, constituting the structure 1 with the plurality of particles 2 as a whole. In addition, the hydrogen production apparatus according to the fourth embodiment has the aluminum bag 21 with the valve 27, as the hydrogen production apparatus according to the first embodiment in FIG. 3. A reason for eliminating the tank 12 and pump P in FIG. 1 is because of a small size of the hydrogen production apparatus of the fourth embodiment. Since an amount water hardly condensed from water vapor by the water vapor separating means 11 is very few, a flow path through which the water flows into the tank 12 was omitted. Accordingly, the tank 12 and the pump P were omitted from FIG. 15. The pump P and the tank 12 may be connected in this order in a water inlet of the water vapor generating means 13.

The reaction chamber 6 is made of quartz, and a plurality of particles 2 are placed in the chamber to form a multi-layer. In an upper portion of the chamber, a cooling chamber 18, which is made of a quartz tube, is connected to the aluminum bag 21 through the water vapor separating means 11. The separating wall 15 is also made of quartz, and extends through the chamber into the structure 1 which is configured with the plurality of particles 2 to form a multi-layer. Water vapor which is supplied to the front room 7, which is located inside the separating wall 15, can move to the rear room 8, which is located between the separating wall 15 and the chamber, by only passing through the structure 1

A nichrome wire, which is the heating means 9, is wound on an outer side of the reaction chamber 6 so as to cover the structure 1. An electric current is applied to the nichrome wire to generate heat, and a temperature of the structures 1 is controlled by varying the electric current. The reason for not to use waste heat for heating the structures 1 is that this is a small experiment for proving a high rate hydrogen production.

When water vapor is transferred to the reaction chamber 6 from the water vapor generating means 13, the water vapor enters into the front room 7 inside the separating wall 15. Since the rear room 8 of the reaction chamber 6 is located outside the separating wall 15, the front room 7 and the rear room 8 are separated each other by the structure 1 and the separating wall 15. Since the water vapor moves from the front room 7 to the rear room 8, the water vapor inevitably passes through a heated structure 1. Hydrogen is produced when the water vapor is passed through the structure 1. Unreacted water vapor and produced hydrogen are transferred to the water vapor separating means 11 through the rear room 8. In the water vapor separating means 11, since cooling water flows in a pipe which is arranged in the vicinity of the cooling chamber 18, a gas within the cooling chamber 18 is cooled to condense the water vapor into water. Accordingly, the hydrogen and the water vapor are separated and the hydrogen is stored in the aluminum bag 21.

Next, a hydrogen production process using a hydrogen production apparatus according to the fourth embodiment will be explained.

A powder of silicon oxide was used as the particles 2, in which fine particles were removed by washing, diameter of the particles 2 was not less than 40 μm and not more than 63 μm, and a purity of the particles 2 was 99.9%. A total weight of the particles 2 was 20 grams. An electric current was applied to the heating means 9, and a temperature of the structure 1 was set at 1000° C. Then, water vapor was generated by the water vapor generating means 13 for 1.5 hours and passed through the structure 1, and the water vapor which passed through the structure 1 was 112 CC/hour. At this time, the water vapor was condensed into water by the water vapor separating means 11 to remove water, and a remaining gas was collected in the aluminum bag 21.

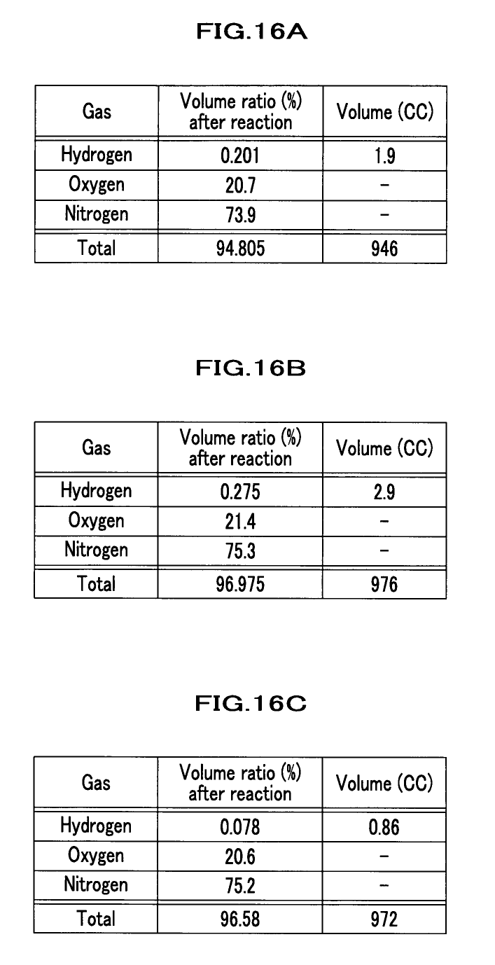

As shown in FIG. 16A, hydrogen was included in the collected gas in which a hydrogen concentration was 0.201% by volume and a hydrogen volume was 1.9 CC. A generation rate of hydrogen was 1.3 CC/hour. Since the structure 1 was made of silicon oxide, the structure 1 is not further oxidized with the water vapor. Therefore, the hydrogen of 1.9 CC was produced by thermal decomposition of the water vapor. Accordingly, it proves that by setting a temperature of the structure 1 at 1000° C., which is a temperature range of waste heat, a hydrogen production rate can be increased by thermal decomposition of water vapor by the structure 1 made of silicon oxide. In addition, since the structure 1 which is made of silicon oxide is not oxidized by water vapor, properties of the structure 1 are not changed by oxidation and a shape of the structure 1 is not changed by volume expansion by oxidation, thereby resulting in stable hydrogen production.

### Fifth Embodiment

In a fifth embodiment, a hydrogen production apparatus which is identical to the fourth embodiment was used. Glass beads whose diameter was 70 μm were used as the particles 2 instead of the powder. A total weight of the glass beads was 30 grams. It was checked again whether or not thermal decomposition of water vapor was caused by the structure 1. Fine particles were removed from the glass beads by washing.

First, the temperature of the structure 1 was set at 1000° C. Then, water vapor was generated for 1.5 hours and a volume of the water vapor which passed through the structure 1 was 81.3 CC/hour. A remaining gas which had passed through the structure 1 and from which the water vapor was removed was collected in the aluminum bas 21. As shown in FIG. 16B, hydrogen was included in the collected gas in which a hydrogen concentration was 0.275% by volume and a hydrogen volume was 2.9 CC. A generation rate of hydrogen was 2.0 CC/hour. Since the structure 1 is composed of the glass beads which are made of silicon oxide, the structure 1 is not further oxidized with the water vapor. Therefore, the hydrogen of 2.9 CC was produced by thermal decomposition of the water vapor. Accordingly, it proves that by setting a temperature of the structure 1 at 1000° C., which is a temperature range of waste heat, a hydrogen production rate can be increased due to thermal decomposition of the water vapor by the structure 1, which is made of silicon oxide. In addition, since the structure 1 which is made of silicon oxide is not oxidized by the water vapor, properties of the structure 1 are not changed by oxidation and a shape of the structure 1 is not changed due to volume expansion by oxidation, thereby resulting in stable hydrogen production.

### Sixth Embodiment

In a sixth embodiment, an experiment which reproduces the fifth embodiment was implemented using a hydrogen production apparatus which is identical to the fourth embodiment. First, the temperature of the structure 1 was set at 1000° C. Then, water vapor was generated for 1.5 hours and a volume of the water vapor which passed through the structure 1 was 81.3 CC/hour. A remaining gas which had passed through the structure 1 and from which the water vapor was removed was collected in the aluminum bas 21. As shown in FIG. 16C, hydrogen was included in the collected gas in which a hydrogen concentration was 0.078% by volume and a hydrogen volume was 0.86 CC. A generation rate of hydrogen was 0.57 CC/hour. Accordingly, hydrogen was produced again consistently in the sixth embodiment. As a result, it was confirmed that by setting a temperature of the structure 1 at 1000° C. which is a temperature range of waste heat, a hydrogen production rate can be increased due to thermal decomposition of water vapor with excellent reproducibility by the structure 1, which is made of silicon oxide.

What is claimed is:

1. A method of producing hydrogen, comprising steps of:
forming a structure, which is formed from at least one of silicon and silicon oxide and has a plurality of holes having an energy concentrated field; and
contacting the structure with water vapor at a temperature which is not less than 500° C. and not more than 1000° C.

2. The method of producing hydrogen according to claim 1, further comprising steps of:
heating up at least one of the structure and the water vapor at the temperature which is not less than 500° C. and not more than 1000° C.; and
contacting the water vapor with the structure by having the water vapor pass through the holes which are continuous holes.

3. The method of producing hydrogen according to claim 1,
wherein a heat for heating up at least one of the structure and the water vapor at the temperature which is not less than 500° C. and not more than 1000° C. is a waste heat.

4. The method of producing hydrogen according to claim 2,
wherein a heat for heating up at least one of the structure and the water vapor at the temperature which is not less than 500° C. and not more than 1000° C. is a waste heat.

5. A hydrogen production apparatus, comprising:
a reaction chamber which has a structure made of at least one of silicon and silicon oxide, the structure including a plurality of continuous holes which have an energy concentrated filed;
water vapor generating means for generating water vapor to be supplied in the reaction chamber;
water vapor supplying means for supplying the water vapor in the reaction chamber; and
heating means for heating up the reaction chamber at a temperature which is not less than 500° C. and not more than 1000° C.,
wherein a hydrogen gas is produced by having the water vapor pass through the structure via the continuous holes which have the energy concentrated filed.

6. The hydrogen production apparatus according to claim 5,
wherein heat which is used by the heating means is waste heat.

7. The hydrogen production apparatus according to claim 5,
wherein the structure has the energy concentrated field among particles by arranging the particles, which are made of at least one of silicon and silicon oxide, at positions where a wave energy specific to one of the silicon and silicon oxide is amplified.

8. The hydrogen production apparatus according to claim 6,
wherein the structure has the energy concentrated field among particles by arranging the particles, which are made of at least one of silicon and silicon oxide, at positions where a wave energy specific to one of the silicon and silicon oxide is amplified.
